(19) United States
(12) Patent Application Publication
(10) Pub. No.: US 2017/0286521 A1
(43) Pub. Date: Oct. 5, 2017

(54) CONTENT CLASSIFICATION

(71) Applicant: McAfee, Inc., Santa Clara, CA (US)

(72) Inventors: Nidhi Singh, Tuebingen (DE); Craig Philip Olinsky, Paderborn (DE)

(73) Assignee: McAfee, Inc., Santa Clara, CA (US)

(21) Appl. No.: 15/089,484

(22) Filed: Apr. 2, 2016

(51) Int. Cl. G06F 17/30; G06N 5/02; G06N 7/00; H04L 29/06

(52) U.S. Cl. CPC G06F 17/30598; H04L 63/1425; G06N 5/022; G06N 7/005

(57) ABSTRACT

Particular embodiments described herein provide for an electronic device that can be configured to analyze data to determine one or more unique topics for a first class and one or more common topics that are common with the first class and a second class, where the topics that are common with the first class and the second class include one or more subtopics, assign one or more classifications to the data based, at least in part, on the one or more subtopics, and store the one or more classifications assigned to the data in memory. The one or more unique topics and one or more common topics can be determined by using a Jaccard Index. Also, the one or more subtopics can be determined using Latent Dirichlet Allocation.

### TECHNICAL FIELD

This disclosure relates in general to the field of information security, and more particularly, to content classification.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. Several attempts to identify malware rely on the proper classification of data. However, it can be difficult and time consuming to properly classify large amounts of data. Hence, significant administrative challenges remain for protecting computers and computer networks from malicious and inadvertent exploitation by malicious software and devices.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for content classification in accordance with an embodiment of the present disclosure;

FIG. 2A is a simplified block diagram illustrating examples details of a portion of a communication system for content classification in accordance with an embodiment of the present disclosure;

FIG. 2B is a simplified block diagram illustrating examples details of a portion of a communication system for content classification in accordance with an embodiment of the present disclosure;

FIG. 2C is a simplified block diagram illustrating examples details of a portion of a communication system for content classification in accordance with an embodiment of the present disclosure;

FIG. 2D is a simplified block diagram illustrating examples details of a portion of a communication system for content classification in accordance with an embodiment of the present disclosure;

FIG. 3 is a simplified block diagram of a table illustrating examples details of a portion of a communication system for content classification in accordance with an embodiment of the present disclosure;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a simplified flowchart illustrating potential operations that may be associated with the communication system in accordance with an embodiment;

FIG. 7 is a simplified flowchart illustrating potential operations that may be associated with the communication system in accordance with an embodiment;

FIG. 8 is a block diagram illustrating an example computing system that is arranged in a point-to-point configuration in accordance with an embodiment;

FIG. 9 is a simplified block diagram associated with an example system on chip (SOC) of the present disclosure; and

FIG. 10 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

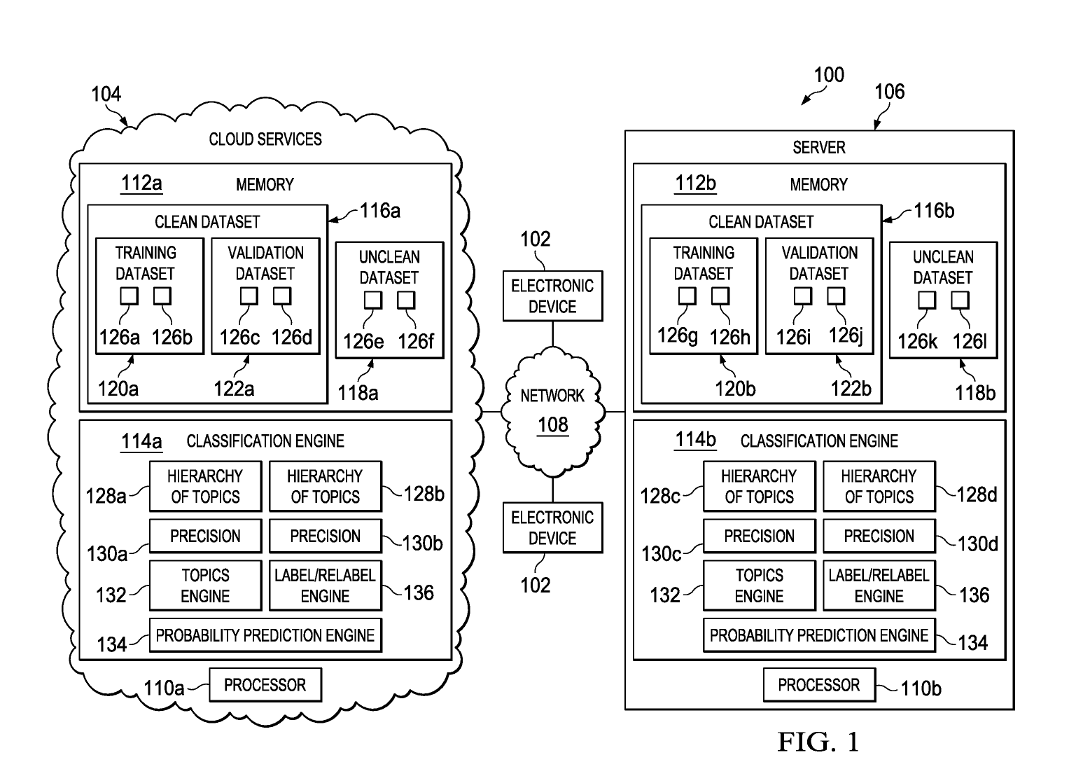

FIG. 1 is a simplified block diagram of a communication system 100 for content classification in accordance with an embodiment of the present disclosure. As illustrated in FIG. 1, an embodiment of communication system 100 can include one or more electronic devices 102, cloud services 104, and a server 106. Cloud services 104 can include a processor 110a, memory 112a, and a classification engine 114a. Memory 112a can include a clean dataset 116a and an unclean dataset 118a. Clean dataset 116a can include a training dataset 120a and a validation dataset 122a. Clean dataset 116a can include one or more instances 126a and 126b. Validation dataset 122a can include one or more instances 126c and 126d. Unclean dataset 118a can include one or more instances 126e and 126f. Classification engine 114a can include one or more hierarchy of topics 128a and 128b, one or more precisions 130a and 130b, a topics engine 132, a probability prediction engine 134, and a label/relabel engine 136. Each one or more precisions 130a and 130b may be associated with a hierarchy of topics. For example, precision 130a can be associated with hierarchy of topics 128a and precision 130b can be associated with hierarchy of topics 128b. Topics engine 132 can determine topics and subtopics of instances 126a-126l. Known topics and subtopics for known classes can be stored in hierarchy of topics 128a-128d. When analyzing data or instances, (e.g., instances 126k and 126l) probability prediction engine 134 can determine a probability that each topic and subtopic found in each instance may be associated with a specific classification.

Server 106 can include a processor 110b, memory 112b, and a classification engine 114b. Memory 112b can include a clean dataset 116b and an unclean dataset 118b. Clean dataset 116b can include a training dataset 120b and a validation dataset 122b. Clean dataset 116b can include one or more instances 126g and 126h. Validation dataset 122b can include one or more instances 126i and 126j. Unclean dataset 118b can include one or more instances 126k and 1261. Classification engine 114b can include one or more hierarchy of topics 128c and 128d, one or more precisions 130c and 130d, topics engine 132, probability prediction engine 134, and label/relabel engine 136. Each one or more precisions 130c and 130d may be associated with a hierarchy of topics. For example, precision 130c can be associated with hierarchy of topics 128c and precision 130d can be associated with hierarchy of topics 128d.

Clean datasets 116a and 116b can include a plurality of datasets with a known and trusted classification, category, or label. As used herein, the terms “classification,” “class,” “category,” and “label” are synonymous and each can be used to describe data that includes a common feature or element or a dataset where data in the dataset includes a common feature or element. Unclean datasets 118a and 118b can include a plurality of datasets that include difficult to classify data or data that includes a classification that may or may not be correct. Unclean datasets 118a and 118b can also include datasets that do not have any classification. Instances 126a-126l may be instances of data in a dataset. Classification engine 114a and 114b can be configured to create one or more multinomial classifiers and one or more hierarchy of topics (e.g., hierarchy of topics 128a) using data from clean data sets 116a and 116b. Classification engine 114a and 114b can also be configured to analyze data in unclean datasets 118a and 118b and assign a classification to the dataset. More specifically, using classification engine 114a and 114b, a classification can be assigned to instances in unclean datasets 118a and 118b. Label/relabel engine 136 can determine if a classification assigned to the instances needs to be changed.

Elements of FIG. 1 may be coupled to one another through one or more interfaces employing any suitable connections (wired or wireless), which provide viable pathways for network (e.g., network 108) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Some current systems can have a large amount of data that needs to be categorized or data that has been assigned a classification. However, sometimes the data is difficult to categorize and can be mischaracterized or incorrectly categorized or classified. For large scales systems, this can result in hundreds of thousands or millions of instances of data that is mischaracterized. Data that is mischaracterized can create significant problems when attempting to sort or analyze the data and when attempting to identify or analyze malware. Some solutions typically address this problem by using methods that involve human intervention. However, such a solution of using human intervention is not feasible in a large-scale collection of data as the man hours required to analyze the data can be cost prohibitive.

One particular problem of content classification and topic modeling includes where a set of target classes (i.e., categories) is composed of only those classes that have a significantly high degree of confusion among themselves. Specifically, the high degree of confusion occurs due to ambiguity in the data space and the probability for two or more classes to be associated with the same data is almost equal or similar in certain regions. These classes can be characterized as ‘hard-to-distinguish’ classes.

In practice, a set of target classes typically includes a mixture of easy-to-distinguish (e.g., linearly separable) classes and hard-to-distinguish classes. Easy-to-distinguish classes can be relatively easy to classify. Hard-to-distinguish classes can have a substantially high degree of confusion and can be hard to classify. Due to the difficulty in classifying hard-to-distinguish classes, these classes often drag down the overall precision of a classification system. Also, hard-to-distinguish classes are often critical ones (e.g., like games, gambling, etc.) and any misclassification among these hard-to-distinguish classes can cause escalations on the customer side and can detract or diminish an end user's experience. Known solutions typically work for problem scenarios where the target set of classes is composed of a mixture of (many) easy-to-distinguish classes and (a few) hard-to-distinguish classes. In such instances, a precision metric relies mostly on the instances that belong to the easy-to-distinguish classes. If the test or validation dataset happens to include only instances of hard-to-distinguish classes, the precision, as well as recall, falls significantly.

A communication system for content classification and topic modeling, as outlined in FIG. 1, can resolve these issues (and others). Given a set of hard-to-distinguish or confusing classes and a labeled dataset, communication system 100 can be configured to classify an unseen document or data into one of the classes with relatively high precision. For example, communication system 100 may be configured to discover latent topics in a given set of classes using Latent Dirichlet Allocation (LDA) and determine the topics that are unique to each class. This can be done in a hierarchical way such that, at each subsequent level in the hierarchy, the latent topics discovered in a previous level are further divided into more granular sub-topics. For classifying new unseen documents, a document can be passed through this hierarchy to identify which topics/sub-topics are present in the document at each level. If, at any level, it is found that the document strongly belongs to one of the unique topic/sub-topic of any of the (hard-to-distinguish) classes, then the document is assigned to the corresponding class. Otherwise, the estimated output at each level in the hierarchy can be compounded in a well-defined way to form final classification output for the document.

LDA is an example of a topic model. It is a generative statistical model that allows sets of observations to explain why some parts of data are similar. For example, if observations are words collected into documents, LDA states that each document is a mixture of a small number of topics and that each word's creation is attributable to one of the document's topics. In LDA, each document may be viewed as a mixture of various topics. This is similar to probabilistic latent semantic analysis (pLSA), except that in LDA the topic distribution is assumed to have a Dirichlet prior. For example, an LDA model might have topics that are cat related and documents that might have topics that are dog related. A topic has probabilities of generating various words, such as milk, meow, and kitten, which can be classified and interpreted as cat related. Naturally, the word cat itself will have high probability given this topic. The dog related topic has probabilities of generating various words such as puppy, bark, and bone might have high probability. Words without special relevance, such as the word “the”, will have roughly even probability between classes (or can be placed into a separate category). Some words are common words amount the classes. For example a cat related topic and a dog related topic might share the common topics of pet, veterinarian, pet food, etc.

In an example, the documents of each class can be segregated from a labeled dataset, “D”. If there are an arbitrary “n” number of classes, then the segregation process will result in n subsets of labeled dataset D, where each subset contains documents of one class. Hereafter, a subset containing document of class “c” can be denoted as Dc. A majority, if not every, of each hard-to-distinguish class may contain one or more latent or hidden topics (e.g., a class sports may contain a football (or American soccer) topic and a basketball topic). A topic is considered to be composed of a set of words that essentially defines that topic. Some of these latent or hidden topics could be unique to a class while others could be common across two or more classes. In order to discover such latent topics in each class, topics engine 132 can be configured to use a LDA on each subset Dc. In performing the LDA, a specify number of topics, “k1”, (e.g., k1=5) to be discovered in each class can be specified.

For every pair of classes, for example, C1 may represent football or American soccer and C2 may represent basketball, the system (e.g., using classification engine 114a) can determine which latent topics are common to the pair, and which ones are unique. For example, classes C1 and C2, may have the common topics of players, ball, scoring, game, coaches, etc. that are common in both classes of football and basketball and topics that are unique in each class, for example, Arsenal® may be unique to C1 as it is the name of a professional football club based in Holloway, London and Crailsheim Merlins® may be unique to C2 as it is the name of is a professional basketball team based in Crailsheim, Germany. The commonality in topics can be found by determining a Jaccard Index of every topic pair in C1 and C2 classes.

The Jaccard Index, also known as the Jaccard similarity coefficient, is a statistic used for comparing the similarity and diversity of sample sets. A Jaccard coefficient can measure similarity between finite sample sets and is defined as the size of the intersection divided by the size of the union of the sample sets. Given two topics, football and basketball (or cats and dogs, topics A and topic B, etc.), each with n binary attributes, the Jaccard coefficient is a useful measure of the overlap that the two topics share with their attributes.

Granular subtopics can be found in the common topics for each class pair by topics engine 132. For example, granular subtopics can be found within the common topics of players, ball, scoring, game, coaches, etc. To do so, LDA can be executed individually on the documents that belong to the common topics for each class, with the difference that the number of subtopics to be discovered may be greater than the number of topics that were identified earlier.

For each, if not a majority of each common topic, one or more latent or hidden topics (e.g., sub-topics) can be identified (e.g., players can include forwards, centers, guards, goalies, point guards, etc.). Communication system 100 can be configured to determine which subtopics are unique for each class pair and which ones are common. The common subtopics can be further drilled down by finding further granular subtopics using LDA with a higher k-value (i.e., the number of topics). Each time LDA is performed, the system is adding one level in the hierarchy of topics/subtopics. The process can be repeated until no further common topics/subtopics in a class pair are found.

Having created the hierarchy of topics for every class pair, an accuracy of topic models at each level of hierarchy can be determined. In an example, inference (using LDA) at each level in the hierarchy can be performed on instances from a validation set. At each level in the hierarchy, the probability with which instance i may belong to topics in class C1 and to topics in class C2 is determined. Then, the determined instance can be assigned to the class for which the probability is a maximum

The accuracy of this inference procedure can be checked by verifying if the true class of instance i in the validation set is same as the predicted/inferred class. This process can be performed for each instance in the validation set and can be used to determine an overall accuracy of topic models at each level of the hierarchy. The accuracy of topics models can be normalized at each level of hierarchy such that the accuracy at all levels add to 1.

In a test phase, each unforeseen instance in a test or validation dataset (e.g., validation data set 122a) can be classified into one of the hard-to-distinguish classes. In order to do so, the system can begin with the first level in the hierarchy and compute the probability with which an instance may belong to topics of each class at that level in the hierarchy. If the topic with maximum probability is unique to either of the classes, then the instance can be assigned to that class. But, if the topic with maximum probability is a ‘common’ topic, then the system can move on to second level in the hierarchy.

At the second level, the system again computes the probability with which an instance may belong to granular subtopics of each class at the second level. If the topic with maximum probability is unique to either of the classes at the second level, then the system can assign the instance to that class. If not, the system can move further down the hierarchy and repeat this process. If at the end or leaf level of the hierarchy, the instance still belongs to one of the common subtopics, then the system can compute the weighted average of the output of all levels in the hierarchy. The weight of each level in the hierarchy equals the (normalized) accuracy of that level (e.g., the accuracy of topics models can be normalized at each level of hierarchy). The instance is then assigned to the class with the highest weighted score.

In an example, communication system 100 can be configured to partition a clean dataset into a training dataset (e.g., training dataset 120) and a validation dataset (e.g., validation dataset 122a). The training dataset can be used to build a hierarchy of topics. Using the validation dataset, communication system 100 can determine a precision of the current hierarchy of topics (e.g., hierarchy of topics 128a) and store the precision in a vector (e.g., precision 130a). For example, an instance 126e from an unclean dataset 118a can be read and a probabilistic prediction using classification engine 114a can be determined for each classification (i.e., with what probability may instance 126e belong to each classification). In an example, an exponential weighted forecaster may be used. If for instance 126e, the probability of a predicted best classification is greater than a respective classification threshold in T, or the predicted best classification is the same as the existing classification in unclean dataset 118a, then the system can update training dataset 120a by adding instance 126e to the training dataset and instance 126e can be removed from unclean dataset 118a. The process can be repeated for each instance in unclean dataset 118a until the system has read and analyzed or processed each instance in unclean dataset 118a.

Using threshold T, allows the training dataset to be updated with clean instances extracted from the unclean dataset while the unclean dataset is left with lesser instances that are yet to be processed/cleansed. The updated training dataset can be used by topic engine 132 to discover new topics and sub-topics. The precision of the new hierarchy of topics can be determined using the validation dataset for each classification.

Turning to the infrastructure of FIG. 1, communication system 100 in accordance with an example embodiment is shown. Generally, communication system 100 can be implemented in any type or topology of networks. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102, cloud services 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, electronic devices 102, cloud services 104, and server 106 can include memory elements (e.g., memory 112a and 112b) for storing information to be used in the operations outlined herein. Electronic devices 102, cloud services 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic devices 102, cloud services 104, and server 106 may include an engine or software modules (e.g., classification engines 114a and 114b, topics engine 132, probability prediction engine 134, and label/relabel engine 136) to achieve, or to foster, operations as outlined herein. These engines may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the engines can be implemented as software, hardware, firmware, or any suitable combination thereof. These elements may also include software (or reciprocating software) that can coordinate with other network elements in order to achieve the operations, as outlined herein.

Additionally, electronic devices 102, cloud services 104, and server 106 may include a processor (e.g., processor 110a and 110b) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, engines, modules, and machines described herein should be construed as being encompassed within the broad term ‘processor.’

Electronic devices 102 can be a network element and include, for example, desktop computers, laptop computers, mobile devices, personal digital assistants, smartphones, tablets, or other similar devices. Cloud services 104 is configured to provide cloud services to electronic devices 102. Cloud services may generally be defined as the use of computing resources that are delivered as a service over a network, such as the Internet. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100. Although classification engines 114a and 114b, topics engine 132, probability prediction engine 134, and label/relabel engine 136 are illustrated as being located in cloud services 104 and server 106 respectively, this is for illustrative purposes only. Classification engines 114a and 114b, topics engine 132, probability prediction engine 134, and label/relabel engine 136 could be combined or separated in any suitable configuration. Furthermore, classification engines 114a and 114b topics engine 132, probability prediction engine 134, and label/relabel engine 136 could be integrated with or distributed in another network accessible by electronic devices 102, cloud services 104, and server 106.

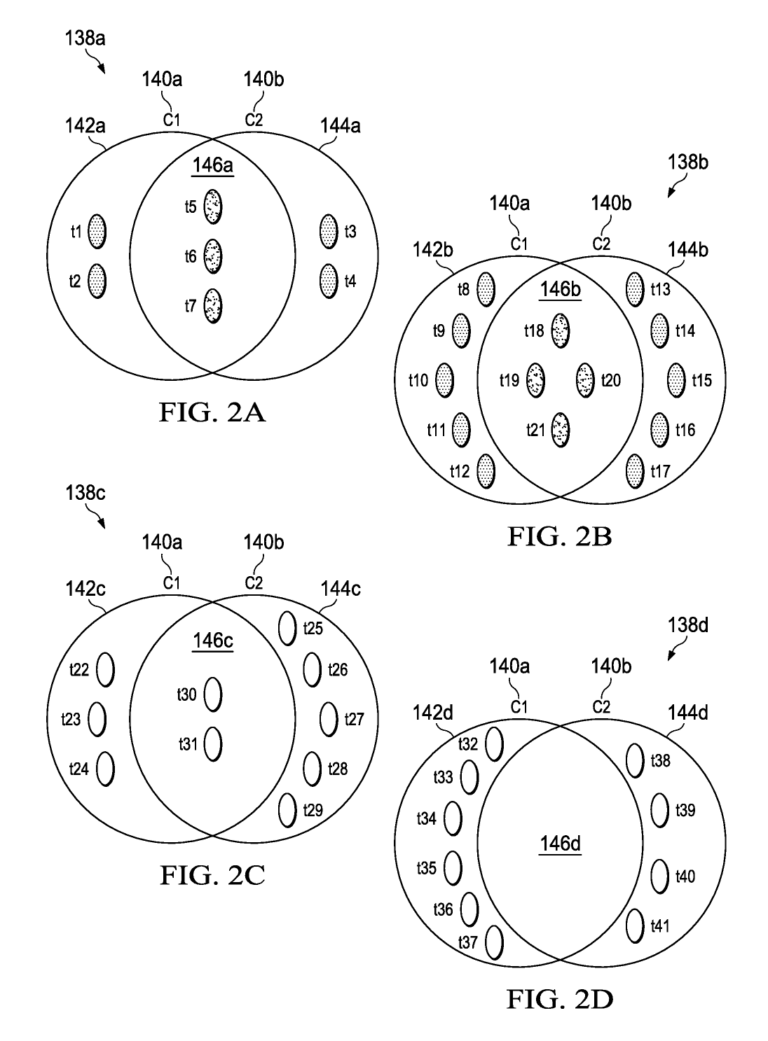

Turning to FIG. 2A, FIG. 2A is a simplified block diagram illustrating examples details of a portion of a communication system for content classification in accordance with an embodiment of the present disclosure. As illustrated in FIG. 2A, a level of hierarchy of topics 138a can be used to analyze a first subject C1 140a (e.g., instance 126a, 126c, or 126e) and a second subject C2 140b (e.g., instance 126b, 126d, or 126f). First subject C1 140a can include first subject unique topics 142a as determined by topics engine 132. For example, first subject unique topics 142a can include topics t1 and t2 that are unique to first subject C1 140a. Second subject C2 140b can include second subject unique topics 144a as determined by topics engine 132. Second subject unique topics 144a can include topics t3 and t4 that are unique to second subject C2 140b. First subject C1 140a and second subject C2 140b can also include common topics 146a. Common topics 146a can include t5-t7 which are common topics of first subject C1 140a and second subject C2 140b.

In an example, first subject C1 140a may represent football or American soccer and second subject C2 140b may represent basketball. Topics t1 and t2 may be topics unique to first subject C1 140a (football) such as a football or soccer ball. Topics t3 and t4 may be topics unique to second subject C2 140b (basketball) such as basketball or basketball hoop. Common topics 146a may be topics that are common to both. For example, t5-t7, may be topics that include players, coaches, scoring, etc. Topics engine 132 can use LDA to find granular subtopics in common topics 146a.

Turning to FIG. 2B, FIG. 2B is a simplified block diagram illustrating examples details of a portion of a communication system for content classification in accordance with an embodiment of the present disclosure. As illustrated in FIG. 2B, a second level of hierarchy of topics 138b, determined by topics engine 132, can include granular subtopics that can be found in the common topics for first subject C1 140a and second subject C2 140b. For example, if one of the topics in common topics 146a was players, first subject C1 140a can include first subject unique subtopics 142b. For example, as determined by topics engine 132 using the Jaccard Index, first subject unique subtopics 142b can include topics t8-t12 that are unique to first subject C1 140a. Also, as determined by topics engine 132 using the Jaccard Index, second subject C2 140b can include second subject unique subtopics 144b. Second subject unique topics 144b can include topics t13 1-t17 that are unique to second subject C2 140b. First subject C1 140a and second subject C2 140b can also include common topics 146b. Common topics 146b can include t18-t21 which are common topics of first subject C1 140a and second subject C2 140b.

In an example, first subject C1 140a may represent football or American soccer and second subject C2 140b may represent basketball. Topics t8-t12 may be granular subtopics of the topic players that are unique to first subject C1 140a (football) such as a goalie, midfielder, sweeper, etc. Topics t13 1-t17 may be granular subtopics of the topic players that are unique to second subject C2 140b (basketball) such as small forward, guard, point guard, etc. Common topics 146b may be topics that are common to both. For example, t18-t21, may be topics that include center, forward, etc. Topics engine 132 can use LDA to find granular subtopics in common topics 146b.

Turning to FIG. 2C, FIG. 2C is a simplified block diagram illustrating examples details of a portion of a communication system for content classification in accordance with an embodiment of the present disclosure. As illustrated in FIG. 2C, a third level of hierarchy of topics 138c, determined by topics engine 132, can include granular subtopics that can be found in the common topics for first subject C1 140a and second subject C2 140b. For example, if one of the topics in common topics 146b was forwards, first subject C1 140a can include first subject unique subtopics 142c. For example, as determined by topics engine 132 using the Jaccard Index, first subject unique subtopics 142c can include topics t22-t24 that are unique to first subject C1 140a. Also, as determined by topics engine 132 using the Jaccard Index, second subject C2 140b can include second subject unique subtopics 144c. Second subject unique topics 144c can include topics t25 1-t29 that are unique to second subject C2 140b. First subject C1 140a and second subject C2 140b can also include common topics 146c. Common topics 146c can include t30 and t31 which are common topics of first subject C1 140a and second subject C2 140b.

In an example, first subject C1 140a may represent football or American soccer and second subject C2 140b may represent basketball. Topics t22-t24 may be granular subtopics of the topic forward that are unique to first subject C1 140a (football) such as center forward, striker, attacker, etc. Topics t25 1-t29 may be granular subtopics of the topic forward that are unique to second subject C2 140b (basketball) such as small forward, strong forward, power forward, etc. Common topics 146c may be topics that are common to both. For example, t30 and t31, may be topics that include a player number or player name. Topics engine 132 can use LDA to find granular subtopics in common topics 146c.

Turning to FIG. 2D, FIG. 2D is a simplified block diagram illustrating examples details of a portion of a communication system for content classification in accordance with an embodiment of the present disclosure. As illustrated in FIG. 2D, a fourth level of hierarchy of topics 138d can include granular subtopics that can be found in the common topics for first subject C1 140a and second subject C2 140b. For example, if one of the topics in common topics 146c was a player number, first subject C1 140a can include player's names associated with the player number, positions associated with the player number, etc. For example, as determined by topics engine 132 using the Jaccard Index, first subject unique subtopics 142d can include topics t32-t37 that are unique to first subject C1 140a. Second subject C2 140b can second subject unique subtopics 144b. Also, as determined by topics engine 132 using the Jaccard Index, second subject unique topics 144 can include topics t38 1-t41 that are unique to second subject C2 140b.

In an example, first subject C1 140a may represent football or American soccer and second subject C2 140b may represent basketball. Topics t32-t37 may be granular subtopics of the topic player number that are unique to first subject C1 140a (football) such as player's names or in football, forwards often wears numbers from 7 to 11. Topics t38-t41 may be granular subtopics of the topic player number that are unique to second subject C2 140b (basketball) such as player names or, in basketball, forwards usually wear numbers from 25 to 40. Common topics 146b may be topics that are common to both. In the example illustrated in FIG. 2D, there are no further common topics between first subject C1 140a and second subject C2 140b. However, it could be possible for further common topics to exist, such as a forward with the same number and/or same name.

Having created the hierarchy of topics for every class pair, an accuracy of topic models at each level of hierarchy can be determined. In order to do so, inference (using LDA) at each level in the hierarchy is performed on instances from a validation set. At each level in the hierarchy, probability prediction engine 134 can determine the probability with which instance i may belong to topics in first subject C1 140a and second subject C2 140b is determined. Then, using label/relabel engine 136, the determined instance can be assigned to the class for which the probability is a maximum or the highest.

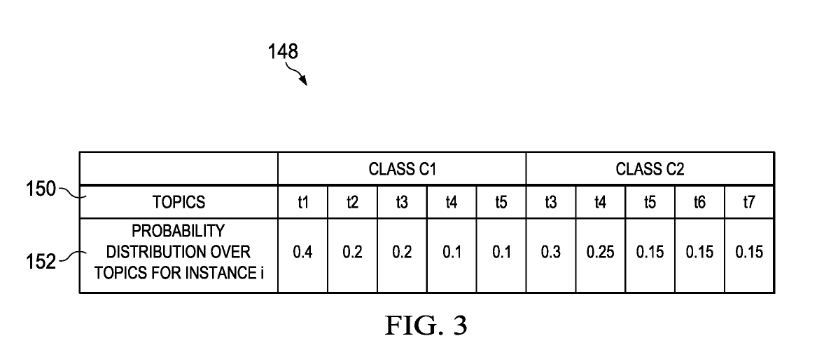

Turning to FIG. 3, FIG. 3 is a simplified block diagram of a table 148 illustrating examples details of a portion of a communication system for content classification in accordance with an embodiment of the present disclosure. Table 148 can include a topics row 150 and a probability distribution over topics for an instance row 152. In an example, instance 126e can be analyzed using hierarchy of topics 128a. Topics t1-t7 may be identified in instance 126e and, using precision 130a, a probability of each topic being associated with a class or classification can be assigned to each topic (and subtopics) by probability prediction engine 135. Because topic t1 has the highest probability, then the classification associated with t1 can be assigned to instance 126e.

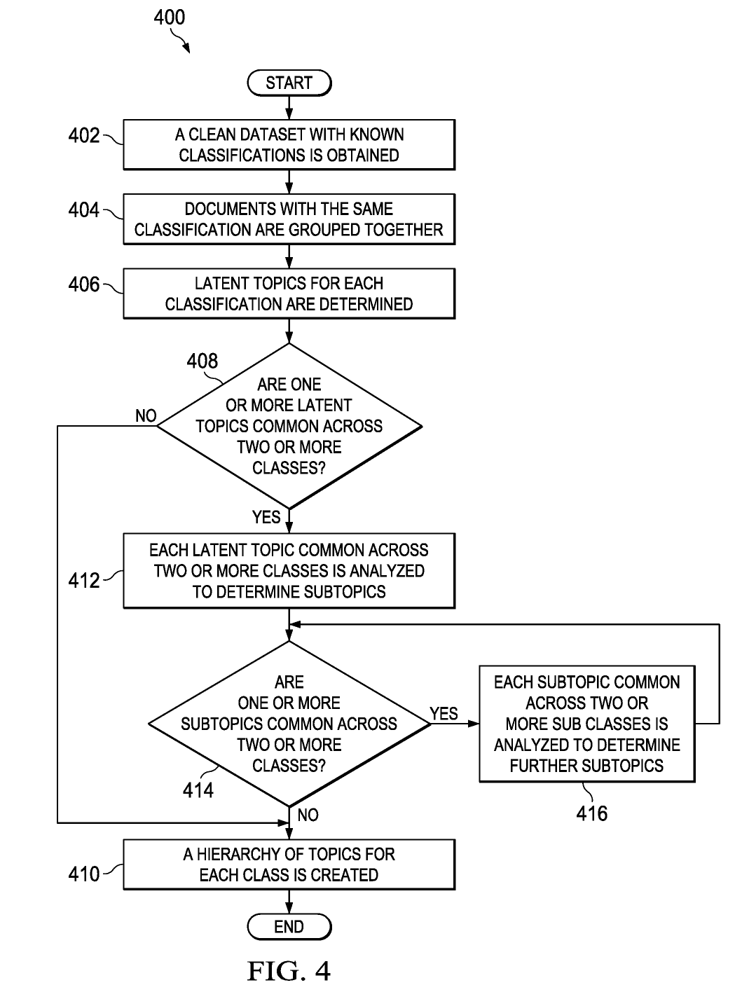

Turning to FIG. 4, FIG. 4 is an example flowchart illustrating possible operations of a flow 400 that may be associated with content classification, in accordance with an embodiment. In an embodiment, one or more operations of flow 400 may be performed by classification engines 114a and 114b, topics engine 132, probability prediction engine 134, and label/relabel engine 136. At 402, a clean dataset with known classifications is obtained. At 404, documents with the same classification are grouped together. At 406, latent topics for each classification are determined. At 408, the system determines if one or more latent topics are common across two or more classes. If one or more latent topics are not common across two or more classes (e.g., as illustrated in FIG. 2D), then a hierarchy of topics for each class is created, as in 410. If one or more latent topics are common across two or more classes, then each latent topic common across two or more classes is analyzed to determine subtopics, as in 412. At 414, the system determines if one or more subtopics are common across two or more classes. If one or more subtopics are not common across two or more classes, then a hierarchy of topics for each class is created, as in 410. If one or more subtopics are common across two or more classes, then each subtopic common across two or more subclasses is analyzed to determine further subtopics, as in 416. At 414, the system determines if one or more subtopics are common across two or more classes.

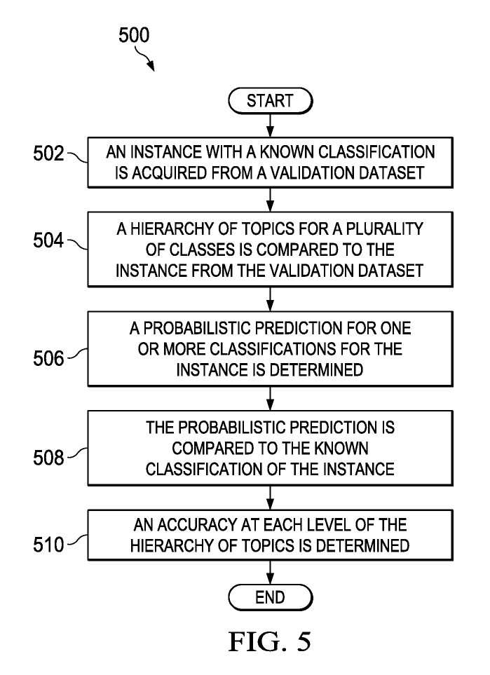

Turning to FIG. 5, FIG. 5 is an example flowchart illustrating possible operations of a flow 500 that may be associated with content classification, in accordance with an embodiment. In an embodiment, one or more operations of flow 500 may be performed by classification engines 114a and 114b, topics engine 132, probability prediction engine 134, and label/relabel engine 136. At 502, an instance with a known classification is acquired from a validation dataset. At 504, a hierarchy of topics for a plurality of classes is compared to the instance from the validation dataset. At 506, a probabilistic prediction for one or more classifications for the instance is determined. At 508, the probabilistic prediction is compared to the known classification of the instance. At 510, an accuracy at each level of the hierarchy of topics is determined. In an example, the accuracy at each level of hierarchy of topics 128a can be stored in precision 130a.

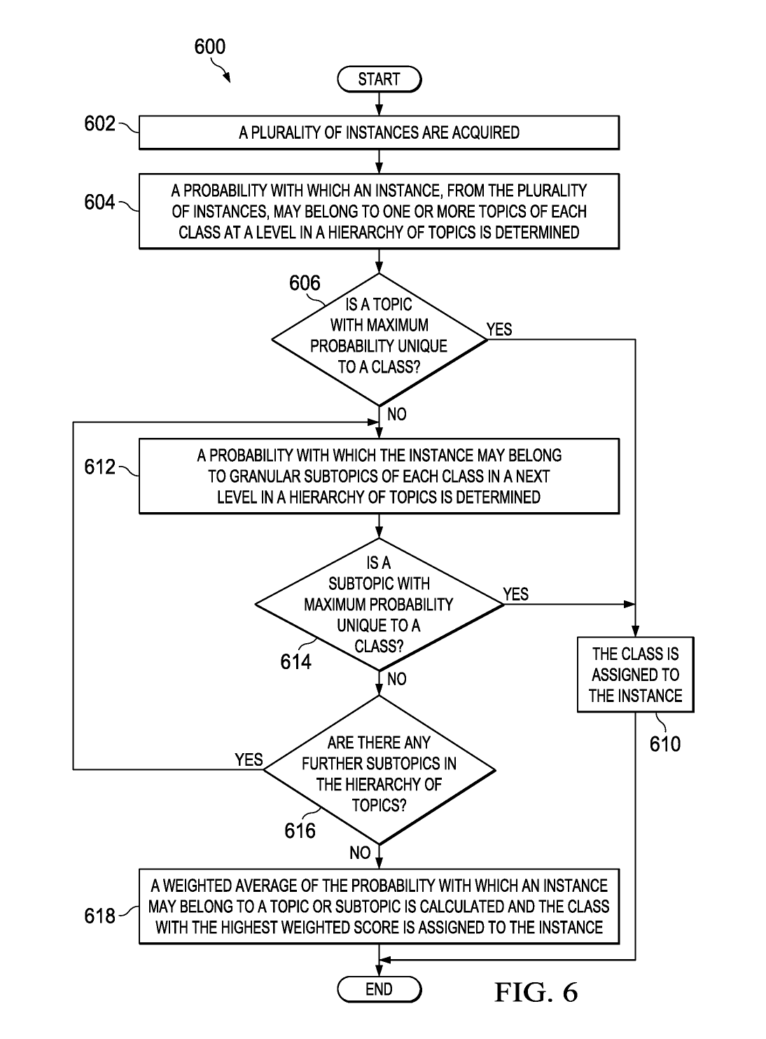

Turning to FIG. 6, FIG. 6 is an example flowchart illustrating possible operations of a flow 600 that may be associated with content classification, in accordance with an embodiment. In an embodiment, one or more operations of flow 600 may be performed by classification engines 114a and 114b, topics engine 132, probability prediction engine 134, and label/relabel engine 136. At 602, a plurality of instances are acquired. At 604, a probability with which an instance, from the plurality of instances, may belong to one or more topics of each class at a level in a hierarchy of topics is determined. At 606, the system determines if a topic with maximum probability unique to a class is determined. If a topic with maximum probability is unique to the class, then the class is assigned to the instance, as in 610. For example, a topic with maximum probability may be unique to the class if the topic is located in unique topics 142a. If a topic with maximum probability is not unique to the class, then a probability with which the instance may belong to granular subtopics of each class in a next level in a hierarchy of topics is determined, as in 612. For example, a topic with maximum probability may not be unique to the class if the topic is located in common topics 146a. At 614, the system determines if a subtopic with maximum probability is unique to a class. If a subtopic with maximum probability is unique to a class, then the class is assigned to the instance, as in 610. If a subtopic with maximum probability is not unique to the class, then the system determines if there are any further subtopics in the hierarchy of topics, as in 616. If there are further subtopics in the hierarchy of topics, then a probability with which the instance may belong to granular subtopics of each class in a next level in a hierarchy of topics is determined, as in 612. If there are not any further subtopics in the hierarchy of topics, then a weighted average of the probability with which an instance may below to a topic of subtopic is calculated and the class with the highest weighted score is assigned to the instance, as in 618.

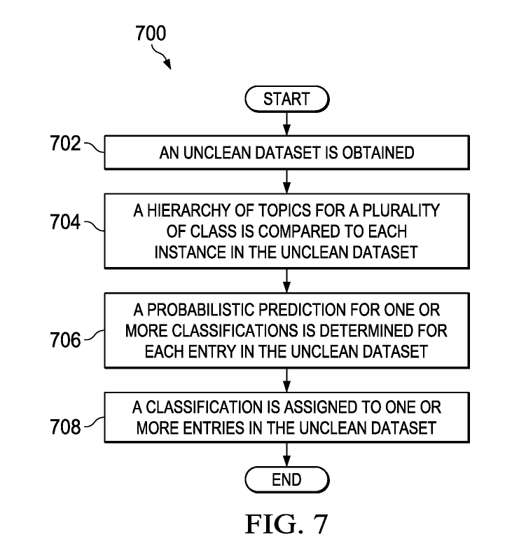

Turning to FIG. 7, FIG. 7 is an example flowchart illustrating possible operations of a flow 700 that may be associated with content classification, in accordance with an embodiment. In an embodiment, one or more operations of flow 700 may be performed by classification engines 114a and 114b, topics engine 132, probability prediction engine 134, and label/relabel engine 136. At 702, an unclean dataset is obtained. At 704, a hierarchy of topics for a plurality of classes is compared to each instance in the unclean dataset. At 706, a probabilistic prediction for one or more classifications is determined for each entry in the unclean dataset. At 708, a classification is assigned to one or more entries in the unclean dataset.

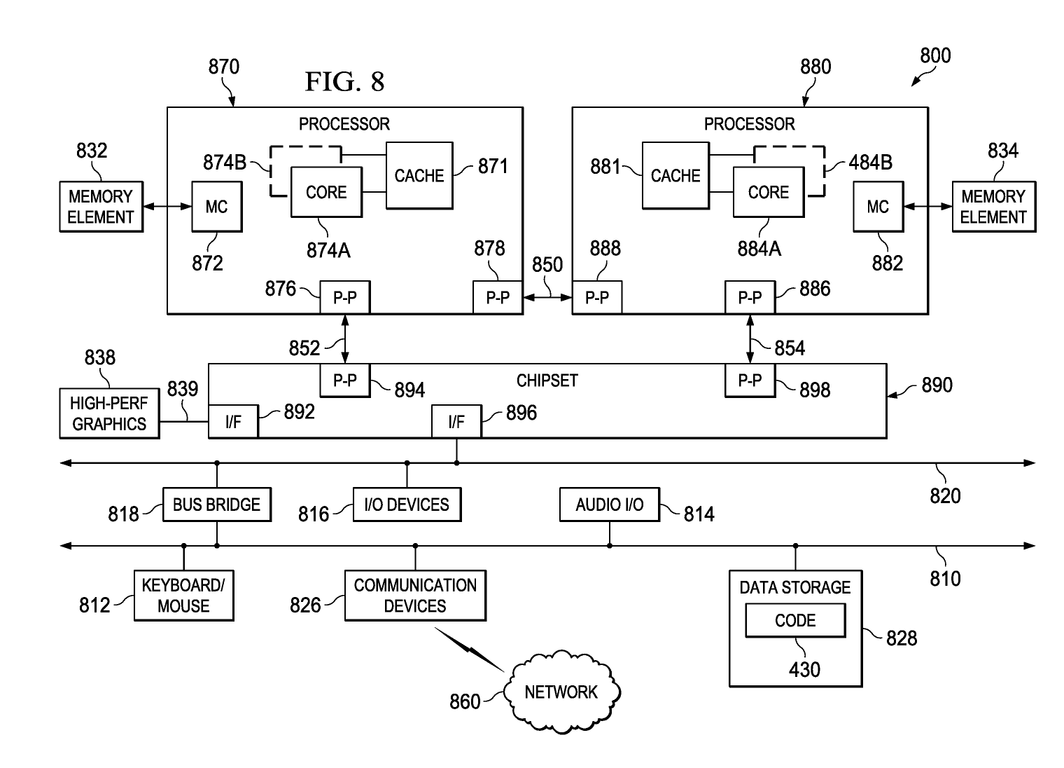

Turning to FIG. 8, FIG. 8 illustrates a computing system 800 that is arranged in a point-to-point (PtP) configuration according to an embodiment. In particular, FIG. 8 shows a system where processors, memory, and input/output devices are interconnected by a number of point-to-point interfaces. Generally, one or more of the network elements of communication system 100 may be configured in the same or similar manner as computing system 800.

As illustrated in FIG. 8, system 800 may include several processors, of which only two, processors 870 and 880, are shown for clarity. While two processors 870 and 880 are shown, it is to be understood that an embodiment of system 800 may also include only one such processor. Processors 870 and 880 may each include a set of cores (i.e., processor cores 874A and 874B and processor cores 884A and 884B) to execute multiple threads of a program. The cores may be configured to execute instruction code in a manner similar to that discussed above with reference to FIGS. 1-7. Each processor 870, 880 may include at least one shared cache 871, 881. Shared caches 871, 881 may store data (e.g., instructions) that are utilized by one or more components of processors 870, 880, such as processor cores 874 and 884.

Processors 870 and 880 may also each include integrated memory controller logic (MC) 872 and 882 to communicate with memory elements 832 and 834. Memory elements 832 and/or 834 may store various data used by processors 870 and 880. In alternative embodiments, memory controller logic 872 and 882 may be discrete logic separate from processors 870 and 880.

Processors 870 and 880 may be any type of processor and may exchange data via a point-to-point (PtP) interface 850 using point-to-point interface circuits 878 and 888, respectively. Processors 870 and 880 may each exchange data with a chipset 890 via individual point-to-point interfaces 852 and 854 using point-to-point interface circuits 876, 886, 894, and 898. Chipset 890 may also exchange data with a high-performance graphics circuit 838 via a high-performance graphics interface 839, using an interface circuit 892, which could be a PtP interface circuit. In alternative embodiments, any or all of the PtP links illustrated in FIG. 8 could be implemented as a multi-drop bus rather than a PtP link.

Chipset 890 may be in communication with a bus 820 via an interface circuit 896. Bus 820 may have one or more devices that communicate over it, such as a bus bridge 818 and I/O devices 816. Via a bus 810, bus bridge 818 may be in communication with other devices such as a keyboard/mouse 812 (or other input devices such as a touch screen, trackball, etc.), communication devices 826 (such as modems, network interface devices, or other types of communication devices that may communicate through a computer network 860), audio I/O devices 814, and/or a data storage device 828. Data storage device 828 may store code 830, which may be executed by processors 870 and/or 880. In alternative embodiments, any portions of the bus architectures could be implemented with one or more PtP links.

The computer system depicted in FIG. 8 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

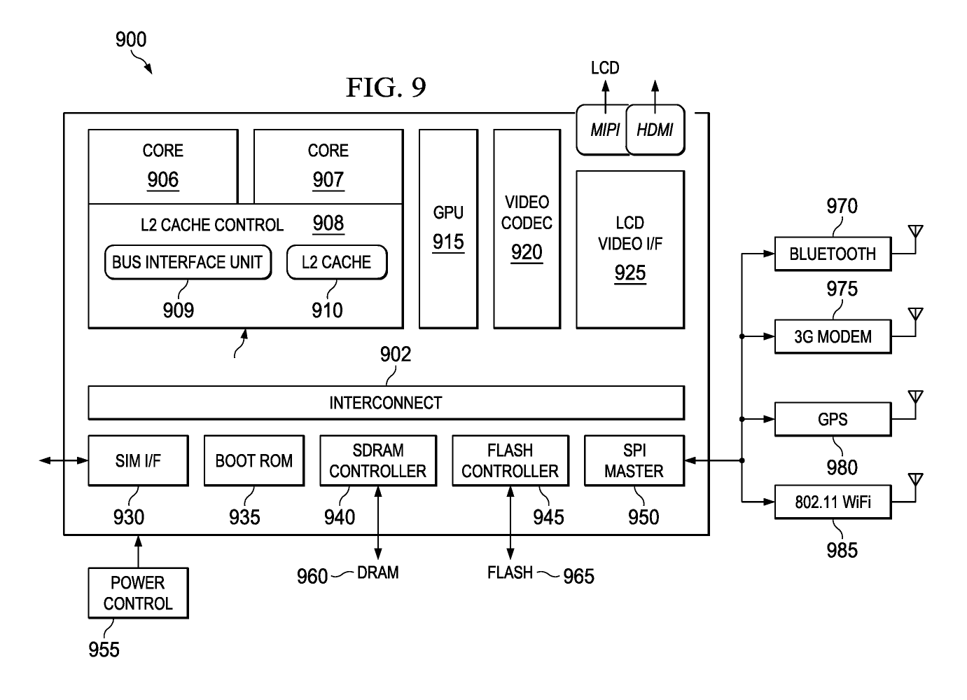

Turning to FIG. 9, FIG. 9 is a simplified block diagram associated with an example SOC 900 of the present disclosure. At least one example implementation of the present disclosure can include the content classification features discussed herein and an SOC component. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 9, SOC 900 may include multiple cores 906-907, an L2 cache control 908, a bus interface unit 909, an L2 cache 910, a graphics processing unit (GPU) 915, an interconnect 902, a video codec 920, and a liquid crystal display (LCD) I/F 925, which may be associated with mobile industry processor interface (MIPI)/high-definition multimedia interface (HDMI) links that couple to an LCD.

SOC 900 may also include a subscriber identity module (SIM) I/F 930, a boot read-only memory (ROM) 935, a synchronous dynamic random access memory (SDRAM) controller 940, a flash controller 945, a serial peripheral interface (SPI) master 950, a suitable power control 955, a dynamic RAM (DRAM) 960, and flash 965. In addition, one or more embodiments include one or more communication capabilities, interfaces, and features such as instances of Bluetooth™ 970, a 3G modem 975, a global positioning system (GPS) 980, and an 802.11 Wi-Fi 985.

In operation, the example of FIG. 9 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

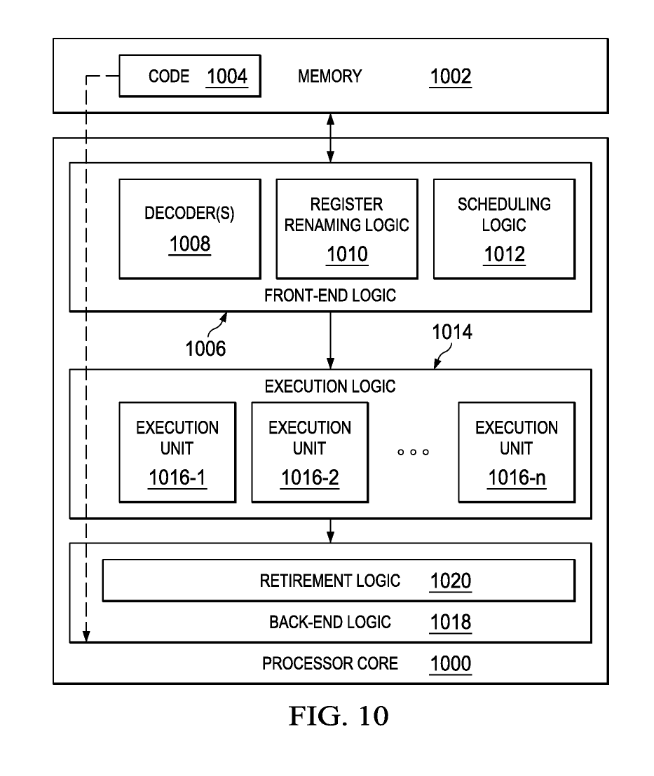

Turning to FIG. 10, FIG. 10 illustrates a processor core 1000 according to an embodiment. Processor core 1000 may be the core for any type of processor, such as a micro-processor, an embedded processor, a digital signal processor (DSP), a network processor, or other device to execute code. Although only one processor core 1000 is illustrated in FIG. 10, a processor may alternatively include more than one of the processor core 1000 illustrated in FIG. 10. For example, processor core 1000 represents one example embodiment of processors cores 1074a, 1074b, 1084a, and 1084b shown and described with reference to processors 1070 and 1080 of FIG. 10. Processor core 1000 may be a single-threaded core or, for at least one embodiment, processor core 1000 may be multithreaded in that it may include more than one hardware thread context (or “logical processor”) per core.

FIG. 10 also illustrates a memory 1002 coupled to processor core 1000 in accordance with an embodiment. Memory 1002 may be any of a wide variety of memories (including various layers of memory hierarchy) as are known or otherwise available to those of skill in the art. Memory 1002 may include code 1004, which may be one or more instructions, to be executed by processor core 1000. Processor core 1000 can follow a program sequence of instructions indicated by code 1004. Each instruction enters a front-end logic 1006 and is processed by one or more decoders 1008. The decoder may generate, as its output, a micro operation such as a fixed width micro operation in a predefined format, or may generate other instructions, microinstructions, or control signals that reflect the original code instruction. Front-end logic 1006 also includes register renaming logic 1010 and scheduling logic 1012, which generally allocate resources and queue the operation corresponding to the instruction for execution.

Processor core 1000 can also include execution logic 1014 having a set of execution units 1016-1 through 1016-N. Some embodiments may include a number of execution units dedicated to specific functions or sets of functions. Other embodiments may include only one execution unit or one execution unit that can perform a particular function. Execution logic 1014 performs the operations specified by code instructions.

After completion of execution of the operations specified by the code instructions, back-end logic 1018 can retire the instructions of code 1004. In one embodiment, processor core 1000 allows out of order execution but requires in order retirement of instructions. Retirement logic 1020 may take a variety of known forms (e.g., re-order buffers or the like). In this manner, processor core 1000 is transformed during execution of code 1004, at least in terms of the output generated by the decoder, hardware registers and tables utilized by register renaming logic 1010, and any registers (not shown) modified by execution logic 1014.

Although not illustrated in FIG. 10, a processor may include other elements on a chip with processor core 1000, at least some of which were shown and described herein with reference to FIG. 10. For example, as shown in FIG. 10, a processor may include memory control logic along with processor core 1000. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagram (i.e., FIGS. 4-7) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

Other Notes and Examples

Example C1 is at least one machine readable medium having one or more instructions that when executed by at least one processor, cause the at least one processor to analyze data to determine one or more unique topics for a first class and one or more common topics that are common with the first class and a second class, where the topics that are common with the first class and the second class include one or more subtopics, assign one or more classifications to the data based, at least in part, on the one or more subtopics, and store the one or more classifications assigned to the data in memory.

In Example C2, the subject matter of Example C1 can optionally include where at least one of the one or more subtopics includes further subtopics and the one or more classifications are assigned to the data based, at least in part on the further subtopics.

In Example C3, the subject matter of any one of Examples C1-C2 can optionally include where the one or more unique topics and one or more common topics are determined by using a Jaccard Index.

In Example C4, the subject matter of any one of Examples C1-C3 can optionally include where the one or more subtopics are determined using Latent Dirichlet Allocation.

In Example C5, the subject matter of any one of Examples C1-C4 can optionally include one or more instructions that when executed by at least one processor, cause the at least one processor to determine a previously assigned classification for the data, and compare the previously assigned classification to the assigned one or more classifications.

In Example C6, the subject matter of any one of Example C1-C5 can optionally include where a probability of the data being associated with a specific classification is determined for each of the one or more subtopics.

In Example C7, the subject matter of any one of Example C1-C6 can optionally include where the data is located in an unclean dataset and is moved to a clean dataset after then one or more classifications are assigned to the data.

In Example A1, an apparatus can include a memory, a classification engine configured to analyze data to determine one or more unique topics for a first class and one or more common topics that are common with the first class and a second class, where the topics that are common with the first class and the second class include one or more subtopics, assign one or more classifications to the data based, at least in part, on the one or more subtopics, and store the one or more classifications assigned to the data in memory.

In Example, A2, the subject matter of Example A1 can optionally include where at least one of the one or more subtopics includes further subtopics and the one or more classifications are assigned to the data based, at least in part on the further subtopics.

In Example A3, the subject matter of any one of Examples A1-A2 can optionally include where the one or more unique topics and one or more common topics are determined by using a Jaccard Index.

In Example A4, the subject matter of any one of Examples A1-A3 can optionally include where the one or more subtopics are determined using Latent Dirichlet Allocation.

In Example A5, the subject matter of any one of Examples A1-A4 can optionally include where the classification engine is further configured to determine a previously assigned classification for the data, and compare the previously assigned classification to the assigned one or more classifications.

In Example A6, the subject matter of any one of Examples A1-A5 can optionally include where a probability of the data being associated with a specific classification is determined for each of the one or more subtopics.

In Example AA1, an apparatus can include a means for analyzing data to determine one or more unique topics for a first class and one or more common topics that are common with the first class and a second class, where the topics that are common with the first class and the second class include one or more subtopics, means for assigning one or more classifications to the data based, at least in part, on the one or more subtopics, and means for storing the one or more classifications assigned to the data in memory.

In Example, AA2, the subject matter of Example AA1 can optionally include where at least one of the one or more subtopics includes further subtopics and the one or more classifications are assigned to the data based, at least in part on the further subtopics.

In Example AA3, the subject matter of any one of Examples AA1-AA2 can optionally include where the one or more unique topics and one or more common topics are determined by using a Jaccard Index.

In Example AA4, the subject matter of any one of Examples AA1-AA3 can optionally include where the one or more subtopics are determined using Latent Dirichlet Allocation.

In Example AA5, the subject matter of any one of Examples AA1-AA4 can optionally include means for determining a previously assigned classification for the data, and means for comparing the previously assigned classification to the assigned one or more classifications.

In Example AA6, the subject matter of any one of Examples AA1-AA5 can optionally include where a probability of the data being associated with a specific classification is determined for each of the one or more subtopics.

In Example AA7, the subject matter of any one of Examples AA1-AA6 can optionally include where the data is located in an unclean dataset and is moved to a clean dataset after then one or more classifications are assigned to the data

Example M1 is a method including analyzing data to determine one or more unique topics for a first class and one or more common topics that are common with the first class and a second class, where the topics that are common with the first class and the second class include one or more subtopics, assigning one or more classifications to the data based, at least in part, on the one or more subtopics, and storing the one or more classifications assigned to the data in memory.

In Example M2, the subject matter of Example M1 can optionally include where at least one of the one or more subtopics includes further subtopics and the one or more classifications are assigned to the data based, at least in part on the further subtopics.

In Example M3, the subject matter of any one of the Examples M1-M2 can optionally include where the one or more unique topics and one or more common topics are determined by using a Jaccard Index.

In Example M4, the subject matter of any one of the Examples M1-M3 can optionally include where the one or more subtopics are determined using Latent Dirichlet Allocation.

In Example M5, the subject matter of any one of the Examples M1-M4 can optionally include determining a previously assigned classification for the data and comparing the previously assigned classification to the assigned one or more classifications.

In Example M6, the subject matter of any one of the Examples M1-M5 can optionally include a probability of the data being associated with a specific classification is determined for each of the one or more subtopics.

In Example M7, the subject matter of any one of the Examples M1-M6 can optionally include where the data is located in an unclean dataset and is moved to a clean dataset after then one or more classifications are assigned to the data.

Example S1 is a system for content classification, the system including memory, and a classification engine configured for analyzing data to determine one or more unique topics for a first class and one or more common topics that are common with the first class and a second class, where the topics that are common with the first class and the second class include one or more subtopics, assigning one or more classifications to the data based, at least in part, on the one or more subtopics, and storing the one or more classifications assigned to the data in memory.

In Example S2, the subject matter of Example S1 can optionally include where at least one of the one or more subtopics includes further subtopics and the one or more classifications are assigned to the data based, at least in part on the further subtopics.

In Example S3, the subject matter of any one of Examples S1 and S2 can optionally include where the one or more unique topics and one or more common topics are determined by using a Jaccard Index.

In Example S3, the subject matter of any one of Examples S1 and S2 can optionally include where the one or more subtopics are determined using Latent Dirichlet Allocation.

In Example S4, the subject matter of any one of Examples S1-S3 can optionally include where a probability of the data being associated with a specific classification is determined for each of the one or more subtopics.

Example X1 is a machine-readable storage medium including machine-readable instructions to implement a method or realize an apparatus as in any one of the Examples A1-A6, or M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that when executed by at least one processor, cause the at least one processor to:
analyze data to determine one or more unique topics for a first class and one or more common topics that are common with the first class and a second class, wherein the topics that are common with the first class and the second class include one or more subtopics;
assign one or more classifications to the data based, at least in part, on the one or more subtopics; and
store the one or more classifications assigned to the data in memory.

2. The at least one machine readable medium of claim 1, wherein at least one of the one or more subtopics includes further subtopics and the one or more classifications are assigned to the data based, at least in part on the further subtopics.

3. The at least one machine readable medium of claim 1, wherein the one or more unique topics and one or more common topics are determined by using a Jaccard Index.

4. The at least one machine readable medium of claim 1, wherein the one or more subtopics are determined using Latent Dirichlet Allocation.

5. The at least one machine readable medium of claim 1, comprising one or more instructions that when executed by at least one processor, further cause the at least one processor to:
determine a previously assigned classification for the data; and
compare the previously assigned classification to the assigned one or more classifications.

6. The at least one machine readable medium of claim 1, wherein a probability of the data being associated with a specific classification is determined for each of the one or more subtopics.

7. The at least one machine readable medium of claim 1, wherein the data is located in an unclean dataset and is moved to a clean dataset after then one or more classifications are assigned to the data.

8. An apparatus comprising:
memory; and
a classification engine configured to:
analyze data to determine one or more unique topics for a first class and one or more common topics that are common with the first class and a second class, wherein the topics that are common with the first class and the second class include one or more subtopics;
assign one or more classifications to the data based, at least in part, on the one or more subtopics; and
store the one or more classifications assigned to the data in memory.

9. The apparatus of claim 8, wherein at least one of the one or more subtopics includes further subtopics and the one or more classifications are assigned to the data based, at least in part on the further subtopics.

10. The apparatus of claim 8, wherein the one or more unique topics and one or more common topics are determined by using a Jaccard Index.

11. The apparatus of claim 8, wherein the one or more subtopics are determined using Latent Dirichlet Allocation.

12. The apparatus of claim 8, wherein the classification engine is further configured to:
determine a previously assigned classification for the data; and
compare the previously assigned classification to the assigned one or more classifications.

13. The apparatus of claim 8, wherein a probability of the data being associated with a specific classification is determined for each of the one or more subtopics.

14. A method comprising:
analyzing data to determine one or more unique topics for a first class and one or more common topics that are common with the first class and a second class, wherein the topics that are common with the first class and the second class include one or more subtopics;
assigning one or more classifications to the data based, at least in part, on the one or more subtopics; and
storing the one or more classifications assigned to the data in memory.

15. The method of claim 14, wherein at least one of the one or more subtopics includes further subtopics and the one or more classifications are assigned to the data based, at least in part on the further subtopics.

16. The method of claim 14, wherein the one or more unique topics and one or more common topics are determined by using a Jaccard Index.

17. The method of claim 14, wherein the one or more subtopics are determined using Latent Dirichlet Allocation.

18. The method of claim 14, further comprising:
determining a previously assigned classification for the data; and
comparing the previously assigned classification to the assigned one or more classifications.

19. The method of claim 14, wherein a probability of the data being associated with a specific classification is determined for each of the one or more subtopics.

20. The method of claim 14, wherein the data is located in an unclean dataset and is moved to a clean dataset after then one or more classifications are assigned to the data.

21. A system for content classification, the system comprising:
memory; and
a classification engine configured for:
analyzing data to determine one or more unique topics for a first class and one or more common topics that are common with the first class and a second class, wherein the topics that are common with the first class and the second class include one or more subtopics;
assigning one or more classifications to the data based, at least in part, on the one or more subtopics; and
storing the one or more classifications assigned to the data in memory.

22. The system of claim 21, wherein at least one of the one or more subtopics includes further subtopics and the one or more classifications are assigned to the data based, at least in part on the further subtopics.

23. The system of claim 21, wherein the one or more unique topics and one or more common topics are determined by using a Jaccard Index.

24. The system of claim 21, wherein the one or more subtopics are determined using Latent Dirichlet Allocation.

25. The system of claim 21, wherein a probability of the data being associated with a specific classification is determined for each of the one or more subtopics.
